(19) United States
(12) Patent Application Publication
(10) Pub. No.: US 2025/0209512 A1
(43) Pub. Date: Jun. 26, 2025

(54) OFFLINE BUSINESS RECOMMENDATIONS

(71) Applicant: Motorola Mobility LLC, Chicago, IL (US)

(72) Inventors: Krishnan Raghavan, Bangalore (IN); Srivalli Chandana, Bangalore (IN); Nakul Patel, Bangalore (IN)

(73) Assignee: Motorola Mobility LLC, Chicago, IL (US)

(21) Appl. No.: 18/393,901

(22) Filed: Dec. 22, 2023

(51) Int. Cl. G06Q 30/0601; G06Q 20/04; G06Q 20/20; G06Q 20/32

(52) U.S. Cl. CPC G06Q 30/0631; G06Q 20/047; G06Q 20/209; G06Q 20/3221; G06Q 20/3224; G06Q 20/3267

(57) ABSTRACT

In aspects of offline business recommendations, a system can receive payment context data associated with a transaction between a mobile device and an offline business. The system implements a business recommendation manager that can extract business data that identifies the offline business from the payment context data. The business recommendation manager can update a business tracking database with the offline business data that identifies the offline business. In implementations, the offline business data included in the business tracking database can used to provide offline business recommendations to users searching for specific items, particularly from businesses that have little to no online presence.

### BACKGROUND

Digital banking services are redefining traditional banking and can be differentiated from traditional banking services in several ways. For instance, digital banking services allows full-time (e.g., any hour, any day, also referred to as 24/7) access to banking, instant funds transfer between accounts, banking on devices (e.g., smartphones) without any physical bank branches, as well as automated teller machine (ATM) withdrawals without any physical ATMs and bank cards. Due to the popularity of digital banking services, many people have stopped carrying paper currency. In fact, some people have also stopped carrying credit and debit cards because credit and debit card information can be loaded into their digital bank accounts to be used for direct transactions, such as on a smartphone.

### BRIEF DESCRIPTION OF THE DRAWINGS

Aspects of offline business recommendations are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of offline business recommendations can be implemented.

FIGS. 2A, 2B depict aspects of an example system procedure for offline business recommendations in accordance with one or more implementations.

FIG. 3 depicts an example transaction detail graphical user interface (GUI) in accordance with one or more implementations.

FIGS. 4A, 4B depict an example search GUI in accordance with one or more implementations.

FIG. 5 depicts an example transaction history GUI in accordance with one or more implementations.

FIGS. 6A, 6B illustrate a flow chart depicting an example method for offline business recommendations in accordance with one or more implementations.

FIG. 7 illustrates a flow chart depicting another example method for offline business recommendations in accordance with one or more implementations.

FIG. 8 illustrates various components of an example device in which aspects of offline business recommendations can be implemented.

### DETAILED DESCRIPTION

The global banking system is undergoing disruption as digital banking services become increasingly popular. The popularity of digital banking services has caught the attention of companies that are not traditionally seen as providing banking services in the banking industry. Many of these new companies are technology companies that approach digital banking services from a new, more technology-focused perspective. For example, instead of competing directly with existing financial institutions, these technology companies aim to help users achieve financial freedom through services such as money management tools. One aspect of such tools is providing data-driven insights, where companies can collect transaction data to help users by providing additional value-added services.

With the advent of digital payment methods, users are increasingly using these services for transactions at businesses, such as small businesses and street vendors, that have limited or no online presence. This makes discovery of such offline businesses a challenge for potential customers. Even in cases where businesses are able to get their information listed online (e.g., as part of an online mapping service), these businesses are not typically tech savvy enough to provide the information necessary for potential customers to understand what goods and/or services these businesses sell. Because of this, these businesses miss potential sales. The potential customers miss out as well, since they are unaware of nearby businesses that sell the goods and/or services they want to purchase, and instead are forced to travel elsewhere or order from an online business, both of which have higher prices especially when factoring in travel time, cost, and/or shipping.

The concepts and technologies disclosed herein are directed to offline business recommendations. By recommending businesses that do not have a significant online presence, both customers and businesses benefit. The potential customers are able to find businesses that are closer to their current location and businesses are able to generate more revenue by serving customers they otherwise would not have.

According to one aspect disclosed herein, payment context data is captured for each transaction a user completes with an offline business. The payment context data can be captured automatically and/or manually through manual user tagging. The payment context data can include, for example, a location of the offline business, a category associated with the expense, a specific item or items associated with the expense, and a receipt for the transaction.

According to another aspect disclosed herein, a business recommendation service can obtain the payment context data. The business recommendation service can clean the payment context data to remove personal identifying information and duplicate data. The business recommendation service can then store this business data, which can be used to create a business directory of offline businesses that can be used to provide a user (e.g., a potential customer) business recommendations for offline businesses.

According to another aspect disclosed herein, a business recommendation application implemented on a mobile device of a user can present, such as display, the recommendations for offline businesses to a user when asked and/or contextually. In this manner, a user can find one or more offline businesses near them, find one or more offline businesses similar to a business used in a given transaction, receive general recommendations for offline businesses that the user may like, find offline businesses that sell a specific item (e.g., a product or service), sort offline business results by price, and receive other insights about offline businesses.

While features and concepts of offline business recommendations can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

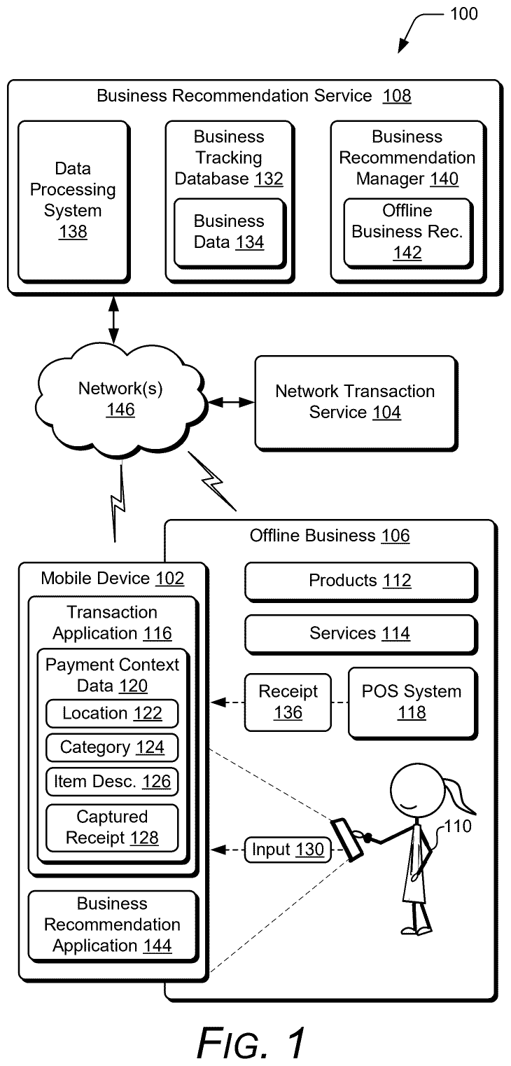

FIG. 1 illustrates an example environment 100 in which aspects of offline business recommendations can be implemented. The environment 100 includes a mobile device 102, a network transaction service 104, an offline business 106, and a business recommendation service 108. The mobile device 102 represents a device that can be used by a user 110 to perform and manage financial transactions to purchase one or more products 112 and/or one or more services 114 (collectively referred to herein as “items”) from the offline business 106. The mobile device 102 also represents a device that can be used by the user 110 to receive recommendations of offline businesses (also referred to herein as offline business recommendations) so as to find an offline business, such as the offline business 106 to purchase specific items from them.

The network transaction service 104 represents a network-based service that is accessible to the mobile device 102 to perform different financial transactions. The network transaction service 104 can be implemented by various entities, such as a banking entity, a digital payment service, an enterprise entity, a trading entity, a data storage and/or management entity, and/or combinations thereof. The user 110, for instance, can utilize a transaction application 116 on the mobile device 102 to access the network transaction service 104 to perform different financial transactions, such as to transfer value amounts (e.g., monetary values) for different purposes, such as to purchase the product(s) 112 and/or the service(s) 114 from the offline business 106. The transaction application 116, for example, represents functionality that enables various finance-related transactions to be performed via the mobile device 102, including access to the network transaction service 104.

The offline business 106 represents an entity with no online presence, or a limited online presence. In one example, the user 110 may want to purchase a specific product or service and may conduct a web search (e.g., via a web browser application on the mobile device 102) to find where that specific product or service can be purchased. Because the offline business 106 has no or limited online presence, it is likely that the web search will not produce meaningful results that identify offline businesses, such as the offline business 106 as one possible business from which to purchase the specific product or service. This results in missed sales opportunities for the owner/operator of the offline business 106. This also may result in the user 110 having to travel a longer distance to find a similar business and/or pay more for the desired product or service. In some instances, the offline business 106 has no online presence, so unless the user receives a personal recommendation for the offline business 106 (e.g., a recommendation from a friend in-person or on a social media platform), the user 110 is unlikely to find the offline business 106 as a potential source for their desired product or service. In other instances, the offline business 106 has limited online presence, such as a social media page with very little or no details, that might not be part of the web search results, or if part of the web search results, might be ignored by the user 110 due to lack of available details or due to a perception that the offline business 106 may not be a reputable source for their desired product or service because of the limited online presence.

The offline business 106 may have a permanent, semi-permanent, or temporary location, which further lends to potential customers locating the business. The offline business 106 may be or may include a traveling component, such as a street vendor cart or food truck. The offline business 106 may be physically located within a standalone structure (e.g., a standalone building), a combined structure (e.g., a shopping center with multiple spaces or a building with multiple offices), a temporary structure (e.g., a kiosk, or a tent), or a movable structure (e.g., a street-side cart).

In the illustrated example, the offline business 106 includes a point-of-sale (POS) system 118. In some implementations, the POS system 118 is configured to accept payment in various physical forms, including paper money, instant peer-to-peer (P2P) money transfer, checks, credit cards, and debit cards. Additionally, or alternatively, the POS system 118 can accept payment via the transaction application 116, in which case the POS system 118 is configured to interact with the transaction application 116 on the mobile device 102 and the network transaction service 104 to facilitate such transactions.

In at least some implementations, and as described above and throughout this disclosure, instances of the offline business 106 may not have an online presence or may have a limited online presence that prevents the offline business 106 from being discovered when the user 110 desires to purchase a specific product or service, such as one of the products 112 or one of the services 114 offered by the offline business 106. The described techniques can be employed to capture payment context data 120 (e.g., via the transaction application 116) for transactions between the user 110 and the offline business 106 (e.g., via the POS system 118). Generally, for each transaction the user makes with an offline business, such as the offline business 106, the transaction application 116 captures payment data associated with the transaction. This payment data is described herein as the payment context data 120. In the illustrated example, the payment context data 120 includes at least a location 122, a category 124, an item description 126, and a captured receipt 128.

The location 122 can be determined automatically by the mobile device 102. For example, the mobile device 102 may utilize the global positioning system (GPS), cellular triangulation, other location determining techniques, or some combination thereof to automatically determine the location 122 at which a transaction occurred. The location 122 can be, for example, a street address and/or longitude/latitude coordinates, or the location 122 may be expressed in other ways. For example, the location 122 may be provided manually by the user 110 as input 130 or a portion thereof.

The category 124 can include an expense category or general category of the product 112 and/or the service 114 that the user 110 purchased at the offline business 106. The user 110 can select the category 124 from a list of predetermined categories, such as predetermined categories can be created by the network transaction service 104, the user 110, or another entity. In some implementations, the category can be directly inferred or auto-populated by the transaction application 116. In some implementations, the transaction application 116 facilitates the creation of new categories, such as based on the input 130 provided by the user 110. The category 124 can be used personally by the user 110 to better understand their spending habits. The category 124 can also be used by the business recommendation service 108 to populate a business tracking database 132 with business data 134 that identifies the products 112 and/or the services 114 offered by the offline business 106 (and other offline businesses, if applicable) using categories, such as the category 124, to categorize the products 112 and/or services 114.

The item description 126 can include a description of the exact item or items (e.g., one or more of the products 112 and/or one or more of the services 114) associated with the transaction. The item description 126 can include details such as item type, manufacturer, model, serial number, UPC, SKU, price, and/or other information that describes the product(s) 112 and/or the service(s) 114 purchased as part of the transaction.

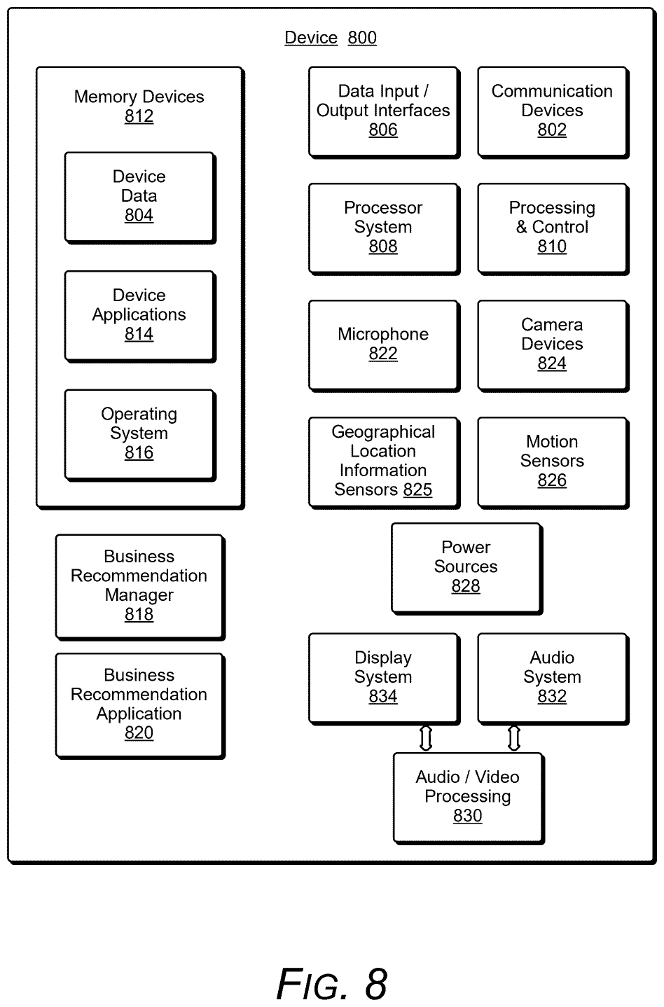

The captured receipt 128 can be an image of a receipt 136 provided by the offline business 106 to the user 110. The receipt 136 can be a paper receipt or a digital receipt. In some implementation, the receipt 136 can be a hand-written paper receipt given by offline business 106 to the user 110. In some implementations, the POS system 118 includes a receipt printer (not shown) that prints the receipt 136 containing pertinent transaction details. In these implementations, the mobile device 102 can be configured with a camera imager, device, or component (e.g., a camera device 824 shown in FIG. 8) and an application (e.g., one of the device applications 814 also shown in FIG. 8). The application can be a camera application that uses the camera imager to capture a photograph of the receipt 136 and use the photograph as the captured receipt 128. Alternatively, the application can be a scanner application that uses the camera imager to create a digitally scanned image of the receipt 136 as the captured receipt 128. The application can be another type of application that works with the camera imager to identify transaction details from the receipt 136. For example, the application can be a computer vision application, such as an optical character recognition application (OCR) that recognizes characters (e.g., letters, numbers, punctuation, and symbols) in the receipt 136. Any one or a combination of the aforementioned applications can be standalone applications, operating system functions, or functionality built-in to another application, such as the transaction application 116. In some implementations, the transaction application 116 includes one or more application programming interfaces (APIs) used to call functions provided by one or more other applications executed locally on the mobile device 102 or elsewhere, such as the business recommendation service 108 and/or the network transaction service 104.

The receipt 136 can be at least partially processed by the mobile device 102 using any of the procedures described above to create the captured receipt 128. In some implementations, the captured receipt 128 is provided by the mobile device 102 to the business recommendation service 108 and/or to the network transaction service 104 for further processing. For example, the captured receipt 128 embodied as a digital image can be shared by the mobile device 102 with the business recommendation service 108 and/or with the network transaction service 104 for further processing, such as to extract pertinent transaction details from the captured receipt 128 using OCR or similar techniques.

The business recommendation service 108 includes a data processing system 138 that receives the payment context data 120. The payment context data 120 can be received from the mobile device 102 (and other devices as the case may be) as shown in the illustrated example. In some implementations, the network transaction service 104 can provide all or a portion of the payment context data 120 associated with transactions executed, in part, by the network transaction service 104. The data processing system 138 can analyze the payment context data 120 to identify and remove any personal identifying information of the user 110. For example, information, such as name, complete address, telephone number, email address, social security number, other government identification (e.g., driver's license), and/or the like, can be identified and removed from the payment context data 120. Moreover, the data processing system 138 can clean the payment context data 120 to remove duplicative data via a data deduplication process. In some implementations, the data processing system 138 can perform additional data processing operations on the payment context data 120. After the payment context data 120 is processed, the processed data can be added to the business tracking database 132 as part of the business data 134.

In addition, the data processing system 138 can extract or determine additional metadata to be incorporated as part of the business data 134. This additional metadata can include, for example, the popularity of the product(s) 112 and/or the service(s) 114, the popularity of the business (e.g., in comparison to other businesses), and pricing information (e.g., a price range for a given item). In some implementations, additional details about the offline business 106, the product(s) 112, and/or the service(s) 114 can be sourced from the owner and/or operator of the offline business 106, and these additional details can be added to the business data 134. In this manner, the owner and/or operator has an additional opportunity to share the product(s) 112 and/or the service(s) 114 offered by the offline business 106 without having to spend time, money, and other resources to develop an explicit online presence.

The business recommendation service 108 also includes a business recommendation manager 140. The business recommendation manager 140 generates offline business recommendations 142 using the business data 134 from the business tracking database 132. The offline business recommendations 142 identify the offline business(es) that can be recommended based on requests received from a business recommendation application 144 implemented by the mobile device 102. The business recommendation application 144 can request offline business recommendations on-demand, such as in response to a request made by the user 110. Alternatively, or in addition, the business recommendation application 144 can request the offline business recommendations automatically. In some implementations, a request can be automatic based on a past transaction history of the user 110. The offline business recommendations can aid the user 110 in finding businesses near the user's current location, businesses similar to a business identified from a given transaction, and/or businesses that sell a particular item, as well as provide functionality to sort the offline business recommendations by businesses based on some criteria (e.g., the price of an item or popularity).

The mobile device 102, the network transaction service 104, the business recommendation service 108, the POS system 118, the data processing system 138, the business tracking database 132, and the business recommendation manager 140 can be implemented in various ways and can include various functionality, examples of which are discussed below with reference to the example device 800 of FIG. 8. Further, various entities of the example environment 100 can be connected and communicate via a network 146. The network 146, for example, can represent a combination of wired and wireless networks via which the mobile device 102, the network transaction service 104, and the business recommendation service 108 can participate in various types of communication, such as wired and/or wireless data communication.

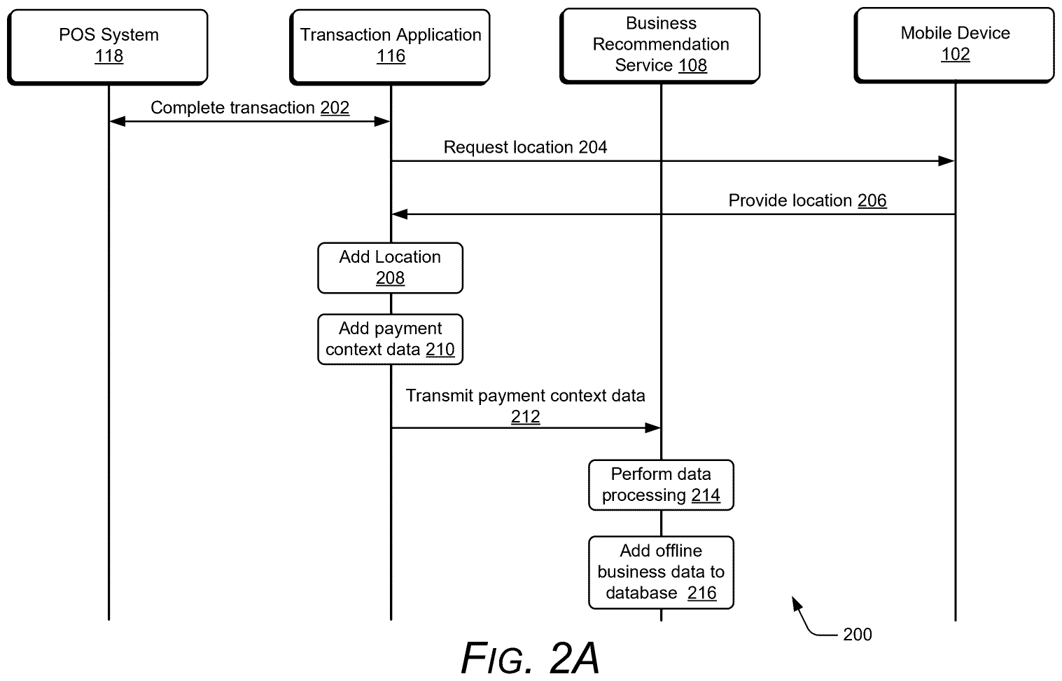

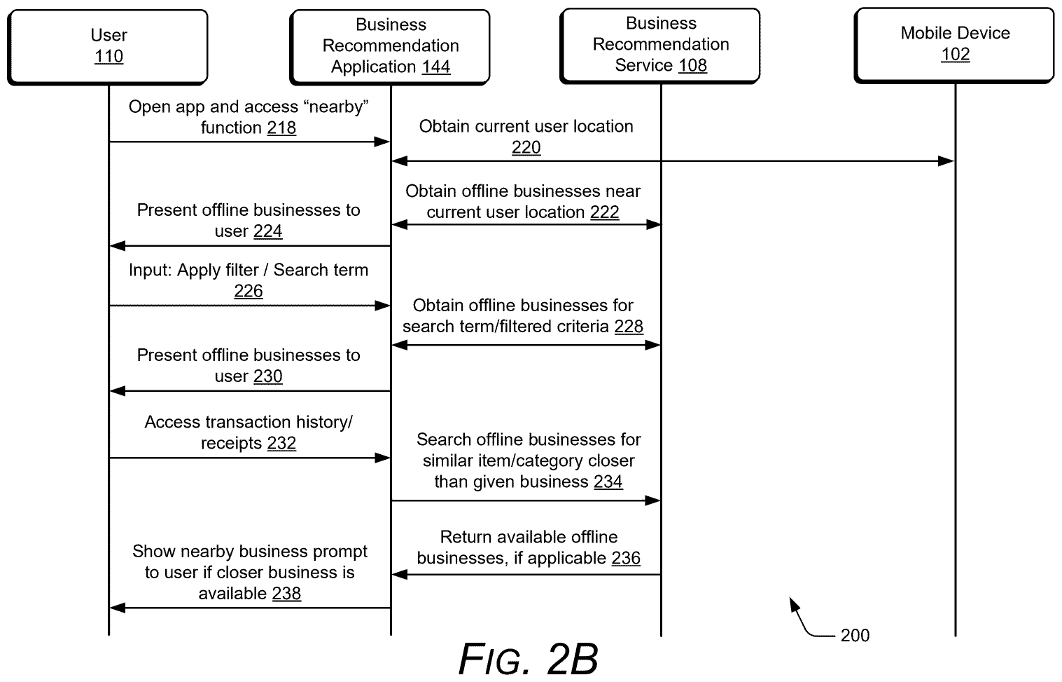

FIGS. 2A, 2B depict aspects of an example system procedure 200 for offline business recommendations in accordance with one or more implementations. The system procedure 200 can be implemented by the systems and devices as described with reference to the environment 100 shown in FIG. 1, and incorporates attributes of the environment 100 introduced above. The example system procedure 200 is described in context of the network transaction service 104 being used to fund purchases made by the user 110. As noted above, the user 110 may fund purchases with cash, credit card, or debit card, in which case details of a transaction can be manually input by the user 110 or obtained from the receipt 136 (e.g., via OCR).

FIG. 2A depicts aspects of the example system procedure 200 for offline business recommendations in accordance with one or more implementations. In particular, the system procedure 200 includes the POS system 118, the transaction application 116, the business recommendation service 108, and the mobile device 102. In the system procedure 200, the transaction application 116 completes a transaction with the POS system 118 on behalf of the user 110 (at 202). The transaction can represent, for example, a purchase of one or more of the product(s) 112 and/or the service(s) 114 provided by the offline business 106 in exchange for payment. In this example, as noted above, payment is made using the network transaction service 104.

In response to completing the transaction (at 202), the transaction application 116 requests a location at which the transaction occurred (at 204) (e.g., the address or latitude/longitude coordinates of the offline business 106). In response, the mobile device 102 can determine the location using GPS, cellular triangulation, other location determining techniques, or some combination thereof. The location can be, for example, a street address and/or longitude/latitude coordinates, or the location may be expressed in other ways. For example, the mobile device 102 may prompt the user to enter the location manually. The mobile device 102 then provides the location to the transaction application 116 (at 206), which then adds the location as part of the payment context data 120 as the location 122 (at 208).

The transaction application 116 adds additional payment context data 120 for the transaction (at 210). For example, the transaction application 116 can prompt the user 110 to provide the category 124, the item description 126, and/or the captured receipt 128. Alternatively, the transaction application 116 can obtain this data automatically. The transaction application 116 may first prompt the user 110 provide the captured receipt 128, and then the transaction application 116 can parse the category 124 and the item description 126 from the captured receipt 128 using OCR, for example. In some implementations, the user 110 can provide the category 124 and the item description 126 using tags, such as hashtags. For example, for an expense of Category “Health”, the user 110 may add “#medicine” for expenses towards medicines, and “#consultation” for expenses made towards the consultation charges, and “#medicaltests” to denote the expenses towards any tests. The transaction application 116 then transmits the payment context data 120 to the business recommendation service 108 (at 212).

The data processing system 138 of the business recommendation service 108 receives the payment context data 120 (at 214) and processes the payment context data 120 to remove any personal identifying information of the user 110 and to eliminate duplicative data (i.e., data deduplication) from the payment context data 120 to create the business data 134. The data processing system 138 adds the business data 134 to the business tracking database 132 for future use (at 216), such as to provide offline business recommendations to the user 110 as will be described in further detail below.

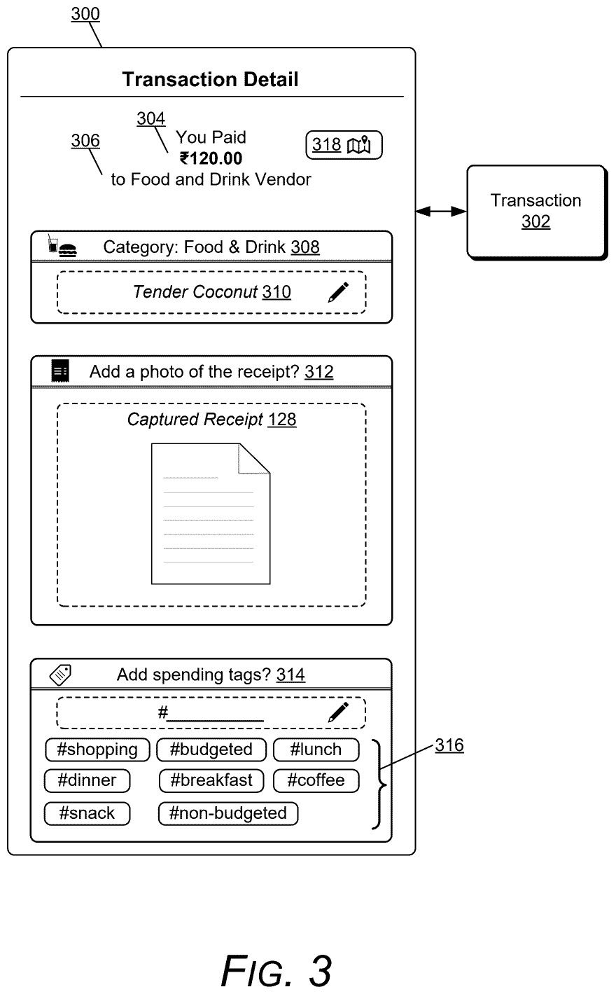

FIG. 2B depicts further aspects of the system procedure 200 for providing offline business recommendations to the user 110 in accordance with one or more implementations. In this particular example, the system procedure 200 includes the user 110, the business recommendation application 144, the business recommendation service 108, and the mobile device 102. In the system procedure 200 (and continuing from FIG. 2A), the user 110 opens the business recommendation application 144 (at 218) and accesses a “nearby business discovery” function, hereinafter nearby function (e.g., nearby function 318 shown in FIG. 3) of the business recommendation application 144 to find offline businesses near a given location, such as the current location of the user 110. The nearby function enables business discovery. The business recommendation application 144 then obtains or requests a current user location from the mobile device 102 (at 220). This operation assumes the user 110 and the mobile device 102 are co-located. Similar to determining the location 122 of the offline business 106, the mobile device 102 can determine the current device and user location using GPS, cellular triangulation, other location determining techniques, manual input by the user 110, or some combination thereof. In some implementations, the nearby function can also be used to discover the businesses near the location of original transaction.

The business recommendation application 144 obtains one or more offline businesses (e.g., the offline business 106) that are near the current user location (at 222). In some implementations, “near” can be specified as a certain maximum distance (e.g., 1 mile or 1.6 kilometers) from the current user location. This distance may be set as default and can be updated or changed by the user 110 based on preferences. For example, the business recommendation application 144 can provide a drop-down menu or other graphical user interface (GUI) element through which the user 110 can define the “near” distance parameter.

After the business recommendation application 144 obtains the offline business(es) near the current user location, the business recommendation application 144 presents or displays the offline business(es) to the user 110 (at 224). For example, the business recommendation application 144 can initiate to display the offline business(es) visually on a display device of the mobile device 102 and/or present the results audibly via an audio output component (e.g., a speaker) of the mobile device 102. Visual presentations can include, but are not limited to, a map indicating the location(s) of the offline business(es) or a list of the offline business(es) (e.g., sorted by nearest to farthest, or any other relevant parameter). Audible presentations can include, but are not limited to, enabling a text-to-speech function of the mobile device 102 to provide the location(s) of the offline business(es). The remaining description assumes that the business recommendation application 144 presents multiple offline businesses visually on a display of the mobile device 102 for the user 110 to browse and interact with.

The business recommendation application 144 also enables the user 110 to filter and/or search the offline businesses (at 226). User 110 may want to filter the offline businesses based on one or more criteria, such as distance, type of business, type of products and/or services offered, business hours, pricing, and/or the like. User 110 may want to search for specific items, such as a specific product or service. The business recommendation application 144 can receive input from the user 110 to apply one or more filters and/or search for one or more items. The business recommendation application 144 can communicate with the business recommendation service 108 to obtain the offline business(es), if any, that fit the search term and/or filter criteria (at 228). The business recommendation application 144 then presents the offline business(es) to the user 110 that fits the search term and/or filter criteria (at 230).

The business recommendation application 144 also enables the user 110 to access their transaction history and/or view their receipts (at 232) (e.g., the captured receipt 128) to identify an item from the transaction history and/or the captured receipt 128, and search nearby offline businesses that sell the same or similar items (or a category of item) that the user 110 previously purchased (at 234). The business recommendation service 108 can return any available offline businesses (at 236), if applicable, and can present or display the offline business(es) to the user 110 for consideration (at 238).

FIG. 3 depicts an example transaction detail GUI 300 in accordance with one or more implementations. The transaction detail GUI 300 can be provided as part of the transaction application 116. The illustrated transaction detail GUI 300 depicts basic information about a transaction 302, including an amount paid 304 (shown in Indian rupees) and a transaction recipient 306 (i.e., the name or a description that identifies the offline business 106). The amount paid 304 and the transaction recipient 306 can be obtained automatically as part of the transaction 302 between the transaction application 116 and the POS system 118 using the network transaction service 104. Alternatively, the amount paid 304 and the transaction recipient 306 can be obtained from a captured receipt 128, as will be further discussed below. Alternatively, a user can manually populate the amount paid 304 and the transaction recipient 306. In the illustrated example, the transaction 302 is for [symbol] 120.00 paid to a “Food and Drink Vendor” for a “Tender Coconut.” This information can be extracted from an uploaded receipt, such as the captured receipt 128. This information can be added manually by the user 110. In other instances, this information can be provided by the network transaction service 104 as part of the details of the transaction.

The transaction detail GUI 300 can also include a category field 308, an item description field 310, and a captured receipt field 312. The category field 308 can include the category 124, the item description field 310 can include the item description 126, and the captured receipt field 312 can include the captured receipt 128. In some implementations, the category field 308 and the item description field 310 are populated using information obtained from the captured receipt 128. The user 110 can edit the category field 308 and/or the item description field 310 if desired.

The transaction detail GUI 300 can also include a spending tag field 314 in which the user 110 can add one or more tags 316 to easily provide context for their transactions. The tags 316 may be predefined and selected by the user 110 and/or may be manually provided by the user 110. The illustrated example also shows “#shopping,” “#snack,” “#coffee,” “#dinner,” “#lunch,” “#breakfast,” “#budgeted,” and “#non-budgeted” example tags 316 added from the spending tag field 314. The example tags 316 can provide the user 110 with additional context about the transaction 302. This can help the user 110 easily identify, for example, a more general category (i.e., #shopping), whether or not the purchase was budgeted (i.e., #non-budgeted or #budgeted), and/or other contextual clues that can aid the user 110 when the user 110 reviews their transaction history.

In this example, the transaction detail GUI 300 also includes a nearby function 318. The user 110 can select a button or selectable control displayed in the GUI on the device display (e.g., a soft button in the illustrated example) associated with the nearby function 318 to show one or more offline businesses that are nearby (e.g., within a certain maximum distance of the current user location) and that sell similar or the same items as described in the item description field 310. In some implementations, when the exact items for the given transaction may not be available, then the business recommendation manager 140 can also show nearby businesses based on one or more of other features like category, inferring items based on one or more user's payment context data with same business, etc.

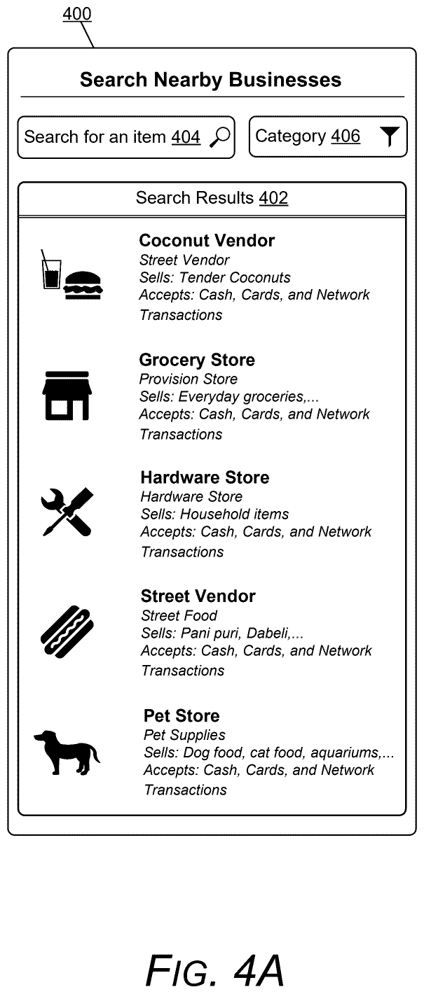

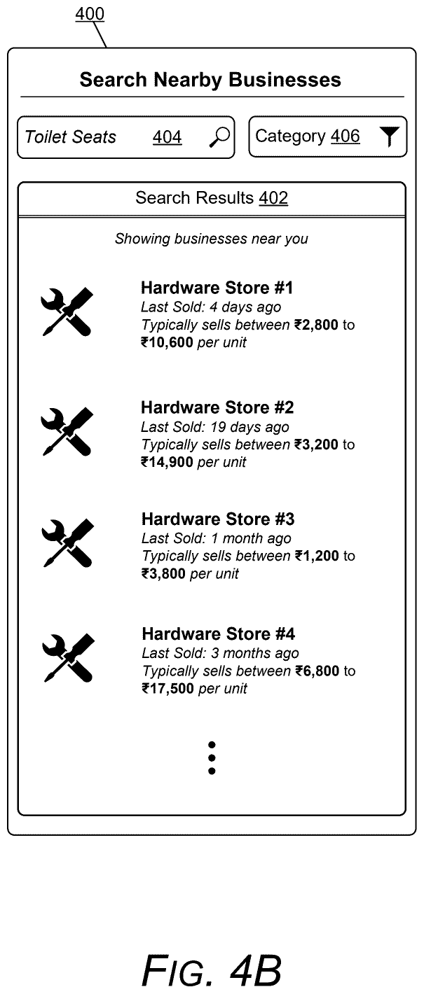

FIGS. 4A, 4B depict an example search GUI 400 in accordance with one or more implementations. The search GUI 400, for example, is presented or initiated for display by the business recommendation service 108 via the business recommendation application 144 on a display device of the mobile device 102. The search GUI 400 can be presented or displayed to the user 110, for example, after the user 110 accesses the nearby function 318 shown in FIG. 3 and the business recommendation application 144 obtains the offline businesses near the current user location (e.g., as shown in operation 222 in FIG. 2B). In some implementations, instead of using the current user location, the location can be provided by the user.

In FIG. 4A, the search GUI 400 provides search results 402 that contain any number of businesses determined to be nearby the current user location. The search results 402 can include information about each business, such as a name, business type, item(s) sold, and accepted forms of payment, as shown in the illustrated example. The information included in each search result can be based on default settings, user preferences, the availability of the information, or both. The search GUI 400 enables the user 110 to search for items by entering one or more search terms in an item search field 404. The search GUI 400 also enables the user 110 to filter the search results 402 by category 406.

As shown in FIG. 4B, the item search field 404 includes “Toilet Seats” as the search term. This search term is sent to the business recommendation service 108 as described above in FIG. 2B (e.g., operation 226). The corresponding search results 402 are shown, including four hardware stores that sell items identifiable as “toilet seats.” The illustrated search results 402 contain additional information provided by the business recommendation manager 140, including most recent sales (shown as “Last Sold”) and typical pricing. This additional data can aid the user 110 in making their decision about which offline business is best suited for their situation. In some implementations, distance from the currently selected location can also be shown as part of additional data.

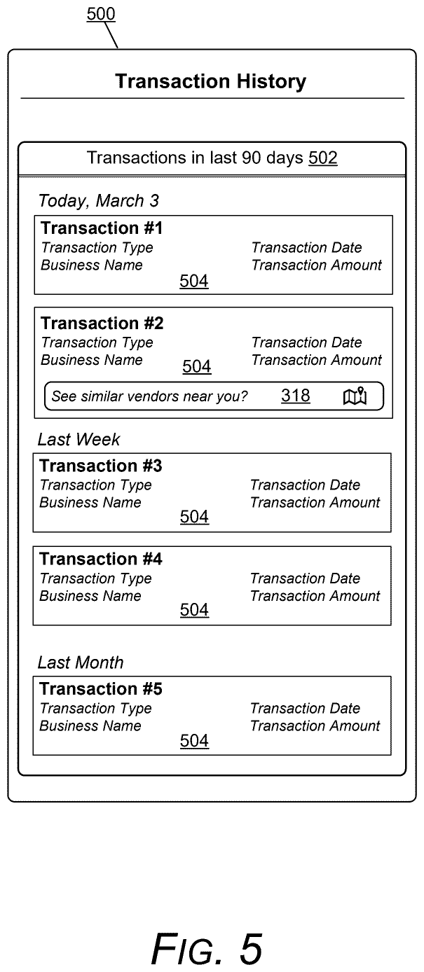

FIG. 5 depicts an example transaction history GUI 500 in accordance with one or more implementations. The transaction history GUI 500, for instance, presents a history of transactions of a particular user, such as the user 110. The transaction history GUI 500 includes a transactions region 502 that includes different transaction entries 504 for transactions completed by and/or on behalf of the user 110. The transaction entries 504 can include information about each transaction, such as transaction type, business name, transaction date, and transaction amount. The transaction history GUI 500 can also include an instance of the nearby function 318 to show one or more businesses that are nearby (e.g., within a certain maximum distance of the current user location) and that sell similar or the same items as described in the transaction entries 504. In the illustrated example, the nearby function 318 is available for “Transaction #2,” but may be made available for multiple transactions.

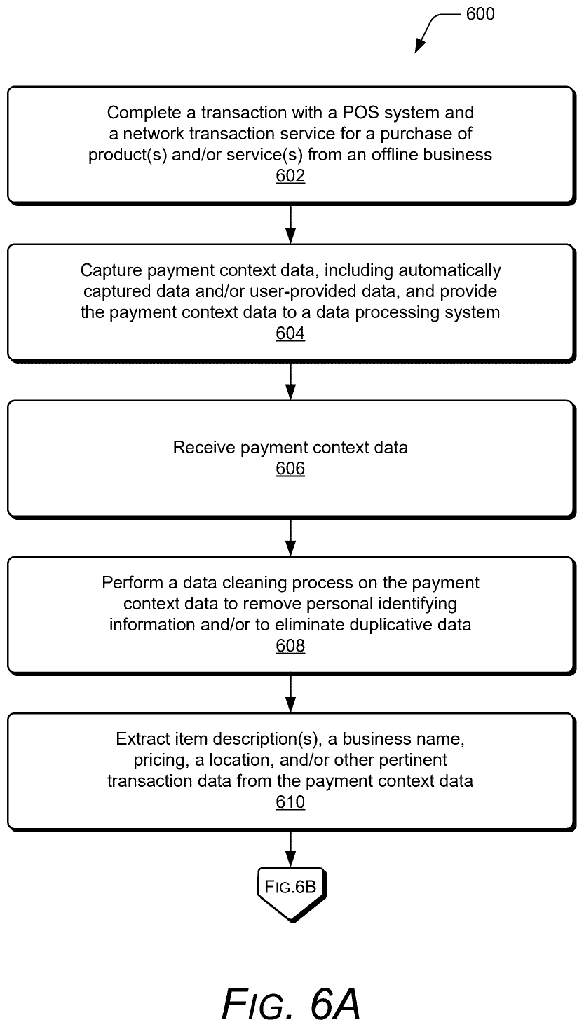

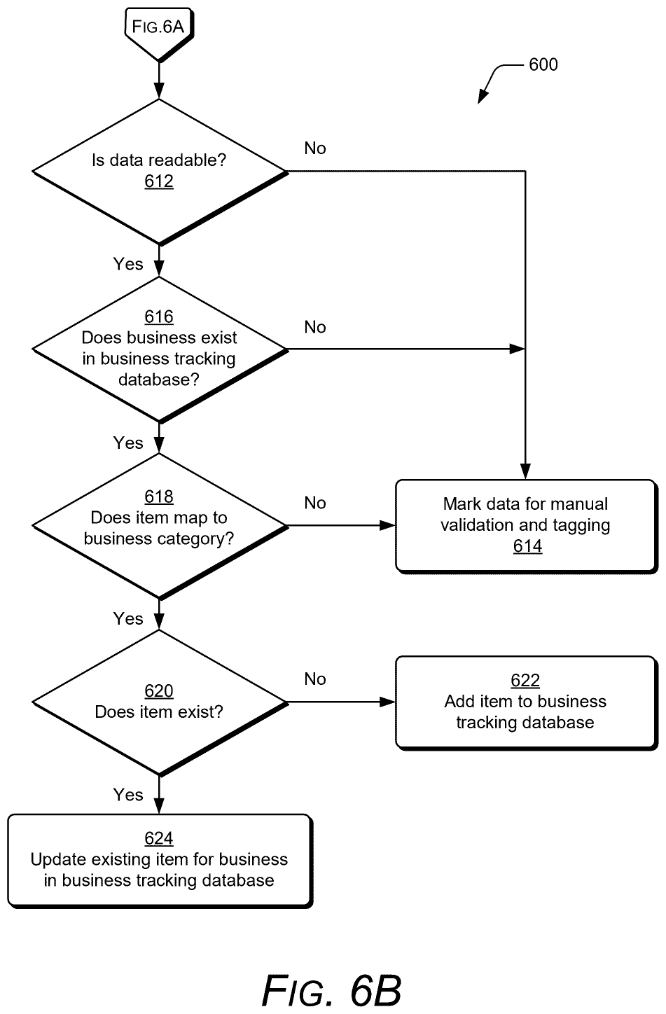

FIGS. 6A, 6B illustrate an example method 600 for offline business recommendations in accordance with one or more implementations. The order in which the method is described is not intended to be construed as a limitation, and any number or combination of the described method operations may be performed in any order to perform a method, or an alternate method.

At 602 (FIG. 6A), a transaction is completed with a POS system and a network transaction service for a purchase of product(s) and/or service(s) from an offline business. For example, the transaction application 116 completes a transaction with the POS system 118 and the network transaction service 104 for a purchase of one or more of the product(s) 112 and/or one or more of the service(s) 114 from the offline business 106. At 604, payment context data is captured, including automatically captured data and/or user-provided data, and the payment context data is provided to a data processing system. For example, the transaction application 116 captures the payment context data 120, including automatically captured data and/or user-provided data, and provides the payment context data 120 to the data processing system 138.

At 606, the payment context data is received. For example, the data processing system 138 receives the payment context data 120. At 608, a data cleaning process is performed on the payment context data to remove personal identifying information and/or to eliminate duplicative data. For example, the data processing system 138 performs a data cleaning process on the payment context data 120, such as to remove personal identifying information and/or eliminate duplicative data from the payment context data. The data processing system 138 may perform other data processing processes as well. At 610, item description(s), a business name, pricing, a location, and/or other pertinent transaction data is extracted from the payment context data. For example, the data processing system 138 extracts item description(s), the business name, pricing, a location, and/or other pertinent transaction data from the payment context data 120.

At 612 (FIG. 6B), a determination is made as to whether the information extracted from the payment context data is readable. For example, the data processing system 138 determines if the item description(s), business name, pricing, location, and/or other pertinent data from the payment context data 120 is readable. For implementations in which the payment context data 120 includes the captured receipt 128, the data processing system 138 can attempt to process the captured receipt 128 to extract the item description(s), the business name, pricing, the location, and/or the other pertinent data. In some instances, however, this data is not readable (e.g., a handwritten receipt). If the information extracted from the payment context data is not readable (i.e., “No” from 612), then at 614, the data is marked for manual validation and tagging. For example, the data processing system 138 marks the data extracted from the payment context data for manual validation and tagging. In implementations, the data processing system 138 can request that the user 110, the network transaction service 104, and/or another entity manually validate the data and tag the data with additional tags (e.g., the tags 316) to provide additional context and/or clarification.

If the information extracted from the payment context data is readable (i.e., “Yes” from 612), then at 616, a determination is made as to whether the business exists in a business tracking database. For example, the data processing system 138 checks the business tracking database 132 to determine if an entry exists for the offline business identified in the data (e.g., by name or some other identifier, such as a number). If the business does not exist in the business tracking database (i.e., “No” from 616), then at 614, the data is marked for manual validation and tagging, as described above.

If the business does exist in the business tracking database (i.e., “Yes” from 616), then at 618, a determination is made as to whether an item described in the data can be mapped to a business category. For example, the data processing system 138 determines if the item described in the data can be mapped to a business category. If the item described in the data is not mapped to a business category (i.e., “No” from 618), then at 614, the data is marked for manual validation and tagging, as described above.

If the item described in the data can be mapped to a business category (i.e., “Yes” from 618), then at 620, a determination is made as to whether the item exists in a business tracking database. For example, the data processing system 138 determines if the item exists in the business tracking database 132. If the item does not exist in the business tracking database (i.e., “No” from 620), then at 622, the item is added to the business tracking database. If the item does exist in the business tracking database (i.e., “Yes” from 620), then at 624, the existing item is updated for the offline business in the business tracking database. For example, the data processing system 138 updates the existing item entry in the business tracking database 132 to reflect that the offline business sells the item.

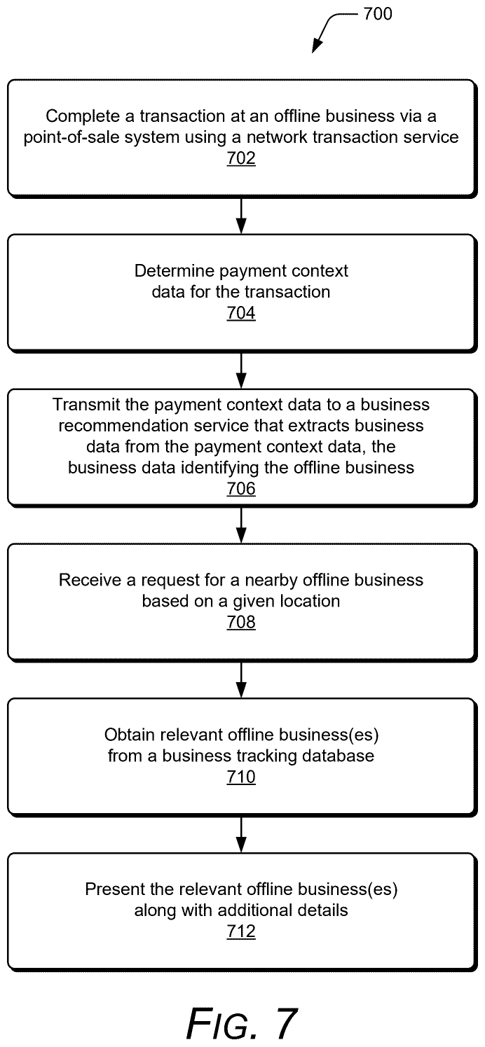

FIG. 7 illustrates another example method 700 for offline business recommendations in accordance with one or more implementations. The order in which the method is described is not intended to be construed as a limitation, and any number or combination of the described method operations may be performed in any order to perform a method, or an alternate method.

At 702, a transaction is completed at an offline business via a point-of-sale system using a network transaction service. For example, the transaction application 116 completes a transaction with the POS system 118 and the network transaction service 104. At 704, payment context data is determined for the transaction. For example, the transaction application 116 at the mobile device 102 determines the payment context data 120 for the transaction. At 706, the payment context data is transmitted to a business recommendation service that extracts business data from the payment context data, the business data identifying the offline business. For example, the transaction application 116 at the mobile device 102 transmits, or otherwise communicates, the payment context data 120 to the to a business recommendation service 108 that extracts the business data 134 from the payment context data, where the business data identifies the offline business.

At 708, a request for a nearby offline business is received. The request can be based on a given location, such as a current location of the mobile device 102 or a location specified by the user 110. For example, the business recommendation application 144 can request nearby businesses (e.g., offline businesses) in response to a search for a specific item. The business recommendation application 144 can request nearby businesses in response to a user utilizing a specific feature of the business recommendation application 144. For example, the user may select a nearby function, such as the example nearby function 318 as shown and described with reference to FIG. 3.

At 710, relevant offline businesses are obtained from the business tracking database. For example, the business recommendation application 144 checks for and obtains relevant offline business(es) from the business tracking database 132. At 712, the relevant offline businesses are presented along with additional details. For example, the business recommendation application 144 presents or displays the relevant offline business(es) for a user along with additional details such as location, pricing, items sold, and/or the like.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 8 illustrates various components of an example device 800, which can implement aspects of the techniques and features for offline business recommendations, as described herein. The example device 800 may be implemented as any of the devices described with reference to the previous FIGS. 1-7, such as any type of a wireless device, mobile device, mobile phone, flip phone, client device, companion device, display device, tablet, computing, communication, entertainment, gaming, media playback, and/or any other type of computing and/or electronic device. For example, the mobile device 102 and/or the a device that implements the business recommendation service 108 described with reference to FIGS. 1-7 may be implemented as the example device 800.

The example device 800 can include various, different communication devices 802 that enable wired and/or wireless communication of device data 804 with other devices. The device data 804 can include any of the various device data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers and/or communication interfaces for cellular phone communication and/or for any type of network data communication.

The example device 800 can also include various, different types of data input/output (I/O) interfaces 806, such as data network interfaces that provide connection and/or communication links between the devices, data networks, and other devices. The data I/O interfaces 806 may be used to couple the device to any type of components, peripherals, and/or accessory devices, such as a computer input device that may be integrated with the example device 800. The I/O interfaces 806 may also include data input ports via which any type of data, information, media content, communications, messages, and/or inputs may be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 may be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes a business recommendation manager 818 and a business recommendation application 820 that implement various aspects of the described features and techniques described herein. The business recommendation manager 818 and the business recommendation application 820 may be implemented with hardware components and/or in software as one of the device applications 814, such as when the example device 800 is implemented as the mobile device 102 and/or as the business recommendation service 108 described with reference to FIGS. 1-7. An example of the business recommendation application 820 is the business recommendation application 144 implemented by the mobile device 102, such as a software application and/or as hardware components in the mobile device. An example of the business recommendation manager 818 is the business recommendation manager 140 implemented by the business recommendation service 108, such as a software application and/or as hardware components in the device. In implementations, the business recommendation manager 818 and/or the business recommendation application 820 may include independent processing, memory, and logic components as a computing and/or electronic device integrated with the example device 800.

The example device 800 can also include a microphone 822 (e.g., to capture an audio recording of a user) and/or camera devices 824 (e.g., to capture images of the receipt), and geographical location information sensors 825 (such as GPS to obtain the current location of the transaction or user), as well as motion sensors 826, such as may be implemented as components of an inertial measurement unit (IMU). The motion sensors 826 may be implemented with various sensors, such as a gyroscope, an accelerometer, and/or other types of motion sensors to sense motion of the device. The motion sensors 826 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 828, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 800 can also include an audio and/or video processing system 830 that generates audio data for an audio system 832 and/or generates display data for a display system 834. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 800. Alternatively, the audio system and/or the display system are external, peripheral components to the example device.

Although implementations of offline business recommendations have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A system, comprising: at least one processor coupled with a memory; and a business recommendation manager configured to cause the system to: receive payment context data associated with a transaction between a mobile device and an offline business; extract, from the payment context data, business data that identifies the offline business; and update a business tracking database with the business data that identifies the offline business.

Alternatively, or in addition to the above-described system, any one or combination of: the payment context data includes a location of the offline business at which the transaction occurs as determined by the mobile device. The payment context data includes at least one of a category of an item purchased as part of the transaction, an item description of the item purchased as part of the transaction, or a captured receipt of the transaction. The business recommendation manager is configured to extract the business data from a captured receipt of the transaction that includes a purchase of an item. The business recommendation manager is configured to obtain, from the business tracking database, additional business data associated with at least one additional offline business; and provide the additional business data to the mobile device for presentation by the mobile device. The business recommendation manager is configured to: receive, from the mobile device, a filter criterion to filter for the additional business data; and obtain the additional business data based on the filter criterion. The business recommendation manager is configured to receive, from the mobile device, a search term to search for the additional business data; and obtain the additional business data based on the search term. The business recommendation manager is configured to receive, from the mobile device, a transaction history entry that identifies at least one of an item or a category of items; and obtain the additional business data based on the transaction history entry.

A mobile device, comprising: at least one processor coupled with a memory; and a transaction application configured to cause the mobile device to: complete a transaction at an offline business via a point-of-sale system using a network transaction service; determine payment context data for the transaction; and transmit the payment context data to a business recommendation service that extracts business data from the payment context data, the business data identifying the offline business.

Alternatively, or in addition to the above-described mobile device, any one or combination of: the transaction application is configured to determine, from the payment context data, a location at which the transaction occurs. The transaction application is configured to capture a receipt of the transaction that includes a purchase of an item, the receipt being provided by the point-of-sale system. The transaction application is configured to determine, from the receipt, at least one of an item description or an item category. The payment context data includes the receipt, and the transaction application is configured to transmit the receipt to the business recommendation service that extracts at least one of an item description, an item category, a purchase price, or a location of the offline business.

A method, comprising: completing a transaction at an offline business via a point-of-sale system using a network transaction service; determining payment context data for the transaction; and transmitting the payment context data to a business recommendation service that extracts business data from the payment context data, the business data identifying the offline business.

Alternatively, or in addition to the above-described method, any one or combination of: the method further comprising: requesting at least one nearby offline business based on a current location of a mobile device; obtaining the business data for the at least one nearby offline business from a business tracking database that stores the business data identifying multiple offline businesses; and displaying the at least one nearby offline business. The method further comprising receiving an item search request specifying a specific item. The method, wherein requesting the at least one nearby offline business based on the current location of the mobile device is further based on the specific item. The method, wherein displaying the at least one nearby offline business includes the at least one nearby offline business that sells the specific item. The method further comprising receiving an input enabling a nearby function. The method, wherein requesting the at least one nearby offline business based on the current location of the mobile device is in response to receiving the input enabling the nearby function.

1. A system, comprising:
at least one processor coupled with a memory; and
a business recommendation manager configured to cause the system to:
receive payment context data associated with a transaction between a mobile device and an offline business;
extract, from the payment context data, business data that identifies the offline business; and
update a business tracking database with the business data that identifies the offline business.

2. The system of claim 1, wherein the payment context data includes a location of the offline business at which the transaction occurs as determined by the mobile device.

3. The system of claim 1, wherein the payment context data includes at least one of a category of an item purchased as part of the transaction, an item description of the item purchased as part of the transaction, or a captured receipt of the transaction.

4. The system of claim 1, wherein the business recommendation manager is configured to extract the business data from a captured receipt of the transaction that includes a purchase of an item.

5. The system of claim 1, wherein the business recommendation manager is configured to:
obtain, from the business tracking database, additional business data associated with at least one additional offline business; and
provide the additional business data to the mobile device for presentation by the mobile device.

6. The system of claim 5, wherein the business recommendation manager is configured to:
receive, from the mobile device, a filter criterion to filter for the additional business data; and
obtain the additional business data based on the filter criterion.

7. The system of claim 5, wherein the business recommendation manager is configured to:
receive, from the mobile device, a search term to search for the additional business data; and
obtain the additional business data based on the search term.

8. The system of claim 5, wherein the business recommendation manager is configured to:
receive, from the mobile device, a transaction history entry that identifies at least one of an item or a category of items; and
obtain the additional business data based on the transaction history entry.

9. A mobile device, comprising:
at least one processor coupled with a memory; and
a transaction application configured to cause the mobile device to:
complete a transaction at an offline business via a point-of-sale system using a network transaction service;
determine payment context data for the transaction; and
transmit the payment context data to a business recommendation service that extracts business data from the payment context data, the business data identifying the offline business.

10. The mobile device of claim 9, wherein the transaction application is configured to determine, from the payment context data, a location at which the transaction occurs.

11. The mobile device of claim 9, wherein the transaction application is configured to capture a receipt of the transaction that includes a purchase of an item, the receipt being provided by the point-of-sale system.

12. The mobile device of claim 11, wherein the transaction application is configured to determine, from the receipt, at least one of an item description or an item category.

13. The mobile device of claim 11, wherein the payment context data includes the receipt, and the transaction application is configured to transmit the receipt to the business recommendation service that extracts at least one of an item description, an item category, a purchase price, or a location of the offline business.

14. A method, comprising:
completing a transaction at an offline business via a point-of-sale system using a network transaction service;
determining payment context data for the transaction; and
transmitting the payment context data to a business recommendation service that extracts business data from the payment context data, the business data identifying the offline business.

15. The method of claim 14, further comprising:
requesting at least one nearby offline business based on a current location of a mobile device;
obtaining the business data for the at least one nearby offline business from a business tracking database that stores the business data identifying multiple offline businesses; and
displaying the at least one nearby offline business.

16. The method of claim 15, further comprising receiving an item search request specifying a specific item.

17. The method of claim 16, wherein requesting the at least one nearby offline business based on the current location of the mobile device is further based on the specific item.

18. The method of claim 16, wherein displaying the at least one nearby offline business includes the at least one nearby offline business that sells the specific item.

19. The method of claim 15, further comprising receiving an input enabling a nearby function.

20. The method of claim 19, wherein requesting the at least one nearby offline business based on the current location of the mobile device is in response to receiving the input enabling the nearby function.
